(19) United States
(12) Patent Application Publication
(10) Pub. No.: US 2009/0174743 A1
(43) Pub. Date: Jul. 9, 2009

(54) Ink ejecting apparatus

(75) Inventor: Toshihiro Hayashi, Suwa-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 12/317,129

(22) Filed: Dec. 19, 2008

(30) Foreign Application Priority Data
Dec. 19, 2007 (JP) 2007-327080

(51) Int. Cl. B41J 29/38; B41J 29/393

(52) U.S. Cl. 347/14; 347/19

(57) ABSTRACT

An ink ejecting apparatus includes: a nozzle, configured to perform a first flushing ejection of ink at a flushing position at a first timing, and configured to perform a dot forming ejection of ink to form an image on a target medium; a first calculator, configured to calculate a first amount of fresh ink assumed to be supplied to the nozzle at a second timing that an ink droplet is ejected in the dot forming ejection; a comparator, configured to compare the first amount with a second amount of fresh ink to be supplied to the nozzle to perform the second ejection; and a second calculator, configured to calculate a third amount of ink to be ejected. by the first flushing ejection so that the first amount becomes no less than the second amount based on the difference and the denaturation of ink.

### BACKGROUND

1. Field of the Invention

This invention relates to an ink ejecting apparatus for ejecting ink droplets from a nozzle or the like and in particular to an art of determining the amount of ink to be ejected in flushing ejection at a predetermined flushing ejection position.

2. Description of the Related Art

Conventionally, in an ink jet printer, ink droplets are ejected from a nozzle to form an image on an image formation medium.

In such an ink jet printer, when ink is ejected from a nozzle, a meniscus face and an ink face in the tip part of the nozzle touches the outside air and thus a solvent, etc., perspires from the face, the viscosity of the ink is increased, and the ingredients of the ink are oxidized, causing the ink to be denatured. Thus, there is a problem in that the ink cannot be ejected as proper droplets and the quality of an image formed on an image formation medium is degraded, for example.

To solve this problem, for example, ink is ejected by a given amount on a regular basis in a flushing ejection area provided outside an image formation area (flushing ejection), thereby ejecting thickened ink and supplying new ink into the nozzle.

In this case, for example, the ink amount in the flushing ejection is set assuming the worst condition. That is, the ink amount is set so as to make it possible to normally eject an ink droplet of the minimum amount most easily subjected to thickening to the farthest end of an image formation area in the following pass with no ink ejected in the immediately preceding pass.

Thus, consumption of the ink amount by the flushing ejection is large; for example, in a printer with a large number of nozzles (for example, an industrial printer), a considerable amount of ink is consumed in flushing ejection and a problem of an increase in the running cost occurs.

As an art for decreasing unnecessary ink consumption, an art of counting the number of ejections (ejection count) of ink from a record head and determining the ink discharge amount based on the number of ejections (ejection count) is known. (For example, refer to JP-A-07-47696.) Although the art of decreasing ink consumption as described above is known, it is not sufficient for decreasing ink consumption and there is a demand for an art capable of more decreasing the ink amount.

### SUMMARY

According to an aspect of the invention, there is provided an ink ejecting apparatus including: a nozzle, configured to perform a first flushing ejection of ink at a flushing position at a first timing, and configured to perform a dot forming ejection of ink to form an image on a target medium while moving in a first direction at least once after the first flushing ejection is performed; a first calculator, configured to calculate a first amount of fresh ink assumed to be supplied to the nozzle at a second timing that an ink droplet is ejected in the dot forming ejection, based on denaturation of ink occurred between the first timing and the second timing, and an amount of ink to be ejected between the first timing and the second timing; a first storage, storing a second amount of fresh ink to be supplied to the nozzle to perform the dot forming ejection at the second timing; a comparator, configured to compare the first amount with the second amount to calculate a difference therebetween; a second calculator, configured to calculate a third amount of ink to be ejected by the first flushing ejection so that the first amount becomes no less than the second amount based on the difference and the denaturation of ink; and a second controller, configured to cause the nozzle to eject the third amount of ink at the first timing.

In the ink ejecting apparatus described above, the second timing may be every timing that an ink droplet is ejected in the dot forming ejection.

In the ink ejecting apparatus described above, the nozzle may be configured to perform a second flushing ejection of ink at a third timing after the dot forming ejection is performed, the first calculator may be configured to calculate a fourth amount of fresh ink assumed to be supplied to the nozzle at the third timing, the comparator may be configured to compare the fourth amount with the second amount, and the second calculator may be configured to calculate the third amount so that the fourth amount becomes no less than the second amount.

In the ink ejecting apparatus described above, the nozzle may be configured to eject different amounts of ink, and the second amount may include different values each of which is associated with one of the different amounts.

The ink ejecting apparatus described above may further includes a second storage, storing a first coefficient indicating a rate of ink denaturation occurred during a first time period that the nozzle moves from a first position that a first ink droplet for the dot forming ejection is ejected to a second position that a second ink droplet for the dot forming ejection is ejected. And, in the ink ejecting apparatus described above, the first calculator may be configured to calculate the first amount at the second position by multiplying the first amount at the first position by the first coefficient and adding an amount of the first ink droplet.

In the ink ejecting apparatus described above, the second calculator may be configured to divide the difference by a second coefficient indicating a rate of ink denaturation occurred between the first timing and the second timing to calculate the third amount.

The ink ejecting apparatus described above may further include a third storage, storing a multiple number (M) indicating a second time period that the nozzle moves from the flushing position to a third position that the nozzle becomes capable of ejecting an ink droplet for the dot forming ejection is what times the first time period. And, in the ink ejecting apparatus described above, the second calculator may be configured to: calculate a third coefficient indicating a rate of ink denaturation occurred during the second time period by raising the first coefficient to the M-th power; and calculate the second coefficient by multiplying the third denaturation rate by a fourth coefficient indicating a rate of ink denaturation occurred during a third time period that the nozzle moves from the third position to the first position.

According to another aspect of the invention, there is provided a method for calculating an amount of ink to be ejected at a flushing ejection by an ink ejecting apparatus including a nozzle, configured to perform a first flushing ejection of ink at a flushing position at a first timing, and configured to perform a dot forming ejection of ink to form an image on a target medium while moving in a first direction at least once after the first flushing ejection is performed, the method including: calculating a first amount of fresh ink assumed to be supplied to the nozzle at a second timing that an ink droplet is ejected in the dot forming ejection, based on denaturation of ink occurred between the first timing and the second timing, and an amount of ink to be ejected between the first timing and the second timing; comparing the first amount with a second amount of fresh ink to be supplied to the nozzle to perform the dot forming ejection at the second timing to calculate a difference therebetween; and calculating a third amount of ink to be ejected by the first flushing ejection so that the first amount becomes no less than the second amount based on the difference and the denaturation of ink.

According to still another aspect of the invention, there is provided a computer program product storing a computer program configured to causing a computer to execute the method described above.

### BRIEF DESCRIPTION OF THE DRAWINGS

Embodiment may be described in detail with reference to the accompanying drawings, in which:

FIG. 1 is a sectional view of a part of a printer according to one embodiment of the invention;

FIG. 2 is a drawing to describe head move and flushing positions according to the embodiment of the invention;

FIG. 3 is a functional block diagram of the printer according to the embodiment of the invention;

FIG. 4 is a drawing to show a raster buffer and a number-of-flushed-droplets retention register according to the embodiment of the invention;

FIG. 5 is a drawing to describe the relationship between a freshness degree coefficient and the time according to the embodiment of the invention; and

FIG. 6 is a flowchart of ink amount determination processing according to the embodiment of the invention.

### DETAILED DESCRIPTION OF THE INVENTION

Referring now to the accompanying drawings, there is shown an embodiment of the invention. The following specific embodiment does not limit the invention according to the scope of Claims and all of elements and combinations thereof described in the embodiment are not necessarily indispensable for the solution means of the invention.

To begin with, an ink jet printer as an example of an ink ejecting apparatus according to one embodiment of the invention will be discussed.

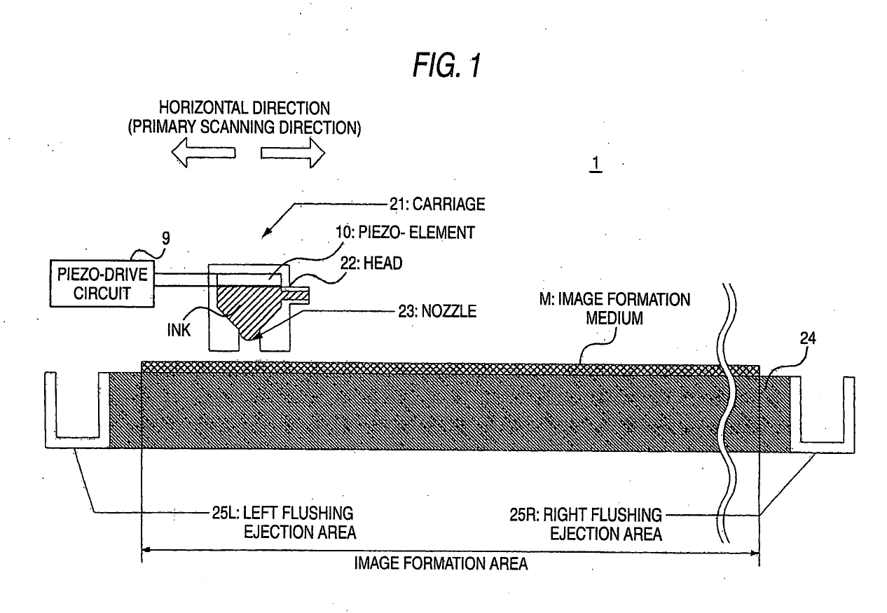

FIG. 1 is a sectional view of a part of the printer according to the embodiment of the invention.

A printer 1 is provided with a platen 24 on which paper (an example of an image formation medium) to form an image is conveyed and is placed.

A carriage 21 that can move in a parallel direction (horizontal direction, primary scanning direction) with a predetermined spacing from the platen 24 is provided above the platen 24. A head 22 and an ink cartridge (not shown) are installed in a carriage 21. The head 22 is formed with a nozzle 23 for ejecting ink and a piezo-element 10 provided in the head 22 is expanded and contracted, whereby ink stored in the head 22 can be ejected. When ink is ejected from the nozzle 23 of the head 22, ink of the amount responsive to the ejected ink amount is supplied from the ink cartridge to the head 22. That is, the ink ejection amount is the same as the amount of fresh ink supplied to the head 22.

A left flushing ejection area 25L and a right flushing ejection area 25R for receiving ink droplets at the flushing ejection time are provided on both sides of the platen 24.

Next, the head move operation and the flushing operation at the image forming time in the printer according to the embodiment of the invention will be discussed.

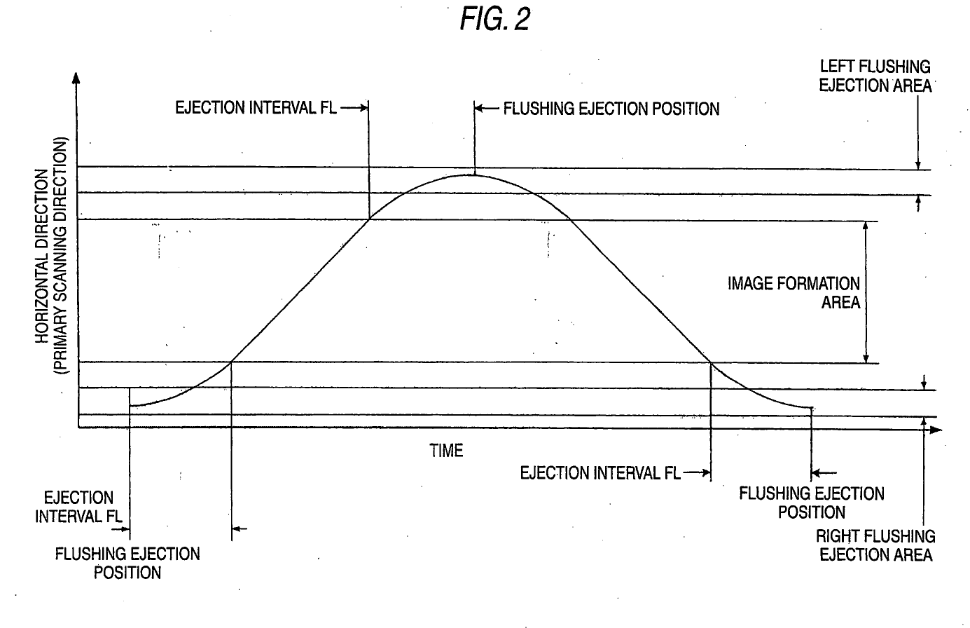

FIG. 2 is a drawing to describe head move and flushing according to the embodiment of the invention. To begin with, when image formation processing of the printer 1 is started, the carriage 1 is moved so that the nozzle 23 is positioned above the right flushing ejection area 25R, and flushing ejection is performed at the position (flushing ejection position). Next, the carriage 21 is moved so that it is accelerated in the left direction and then becomes given speed in an image formation area (IFA: in the embodiment, above an image formation medium M). Then, the carriage 21 is moved so that it is decelerated after exceeding the image formation area and is positioned above the left flushing ejection area 25L. At this time, in the image formation area, ink droplets responsive to the image portion to be formed are ejected from the nozzle 23 of the head 22 installed in the carriage 21.

After this, the image formation medium M is delivered in a secondary scanning direction (in the front direction of the drawing) and the area of the image formation medium M to form the next pass comes just below the move range of the nozzle 23.

Next, when the nozzle 23 is in a position above the left flushing ejection area 25L (flushing ejection position), flushing ejection is performed. Next, the carriage 21 is moved so that it is accelerated in the right direction and then becomes given speed in the image formation area M. Then, the carriage 21 is moved so that it is decelerated after exceeding the image formation area M and is positioned above the right flushing ejection area 25R. At this time, similar processing to that described above is repeated until completion of image formation for all passes to form an image.

Next, the functional configuration of the printer according to the embodiment of the invention will be discussed.

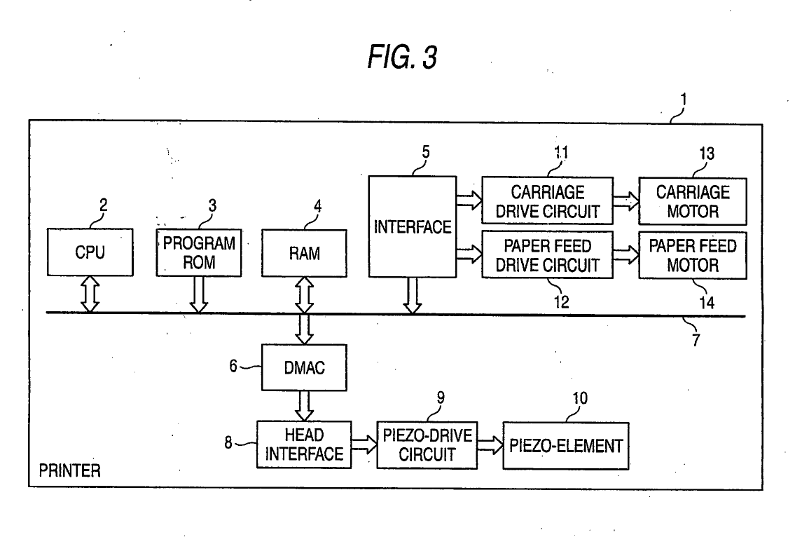

FIG. 3 is a functional block diagram of the printer according to the embodiment of the invention.

In the printer 1, a CPU (Central Processing Unit) 2, program ROM (Read-Only Memory) 3, RAM (Random Access Memory) 4 as an example of freshness degree threshold value storage means, freshness degree coefficient storage means, and multiple storage means, an interface 5, and a DMAC (Direct Memory Access Controller) 6 are connected through a bus 7. The CPU 2, the ROM 3, the RAM 4, and the like correspond to a computer.

A carriage drive circuit 11 and a paper feed drive circuit 12 are connected to the interface 5. A carriage motor 13 for moving the carriage 21 is connected to the carriage drive circuit 11. A paper feed motor 14 for operating a paper feed mechanism (not shown) is connected to the paper feed drive circuit 12.

A head interface 8 is connected to the DMAC 6. A piezo drive circuit 9 is connected to the head interface 8. The piezo drive circuit 9 is connected to the piezo-elements 10 provided in a one-to-one correspondence with the nozzles 23 of the head 22. In the embodiment, the printer 1 has a plurality of nozzles each for ejecting each of colors of ink (for example, yellow, magenta, cyan, and black).

The program ROM 3 stores various programs of a boot program, etc. In the embodiment, the program ROM 3 stores a program for executing ink amount determination processing described later.

The RAM 4 is used as an area for storing the programs and data or is used as a work area for storing data used for processing of the CPU 2. In the embodiment, the RAM 4 stores freshness degree threshold values corresponding to sizes of droplets that can be ejected from each nozzle. The freshness degree is the ink amount of fresh ink assumed to be previously supplied to the nozzle at one point in time, and the freshness degree threshold value is the threshold value of the freshness degree indicating the ink amount of fresh ink to be previously supplied to the nozzle 23 to eject one droplet. The smaller the ink droplet size, the larger the viscosity effect. Thus, the freshness degree threshold value is a larger value as the ink droplet size is smaller.

The RAM 4 stores an ejection interval FL (EIFL). The ejection interval FL is information indicating the time from the flushing ejection position to the starting end of the image formation area and is information indicating the time from the last end of the image formation area to the next flushing ejection position as shown in FIG. 2. In the embodiment, the ejection interval FL is a multiple of the time taken until the nozzle 23 moves from one dot position of the image formation area to the next dot position.

The RAM 4 also stores a freshness degree coefficient indicating the ink denaturation percentage (reference freshness degree coefficient: RFDC) in the time until the nozzle 23 moves from one dot position to the next dot position.

The RAM 4 also stores a raster buffer 4a indicating the correspondence between the ink ejection position through the nozzle and the size of the ink droplet to be ejected (ink amount) for each nozzle. The RAM 4 also stores a number-of-flushed-droplets retention register 4b for retaining information indicating the amount of ink to be flushed at the starting time of each pass (for example, the number of ink droplets) for each nozzle.

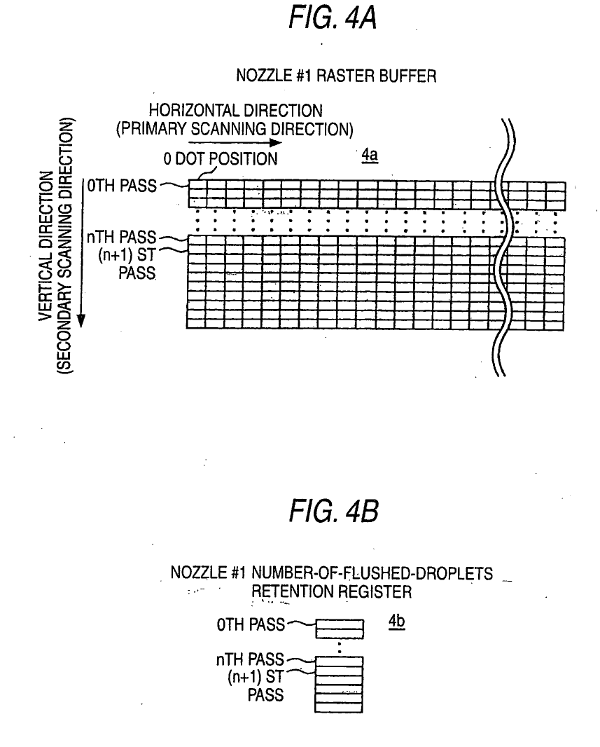

FIG. 4 is a drawing to show the raster buffer and the number-of-flushed-droplets retention register according to the embodiment of the invention. FIG. 4A shows the raster buffer 4a corresponding to one of the nozzles (nozzle #1) and FIG. 4B shows the number-of-flushed-droplets retention register 4b corresponding to one of the nozzles (nozzle #1).

The raster buffer 4a stores ink ejection data (ejected droplet type data: EDTD) indicating the presence or absence of ink ejection and the ink amount if ink is ejected at the dot position. The EDTD forms a matrix including rows corresponding to the passes and columns corresponding to the dot positions. Besides, as shown in FIG. 4A, the rows are arranged in the secondary scanning direction, and the columns are arranged in the primary direction. For example, ejected droplet type data “00” indicates no ink ejection at the dot position; “01” indicates ejection of a droplet of a small size; “10” indicates ejection of a droplet of a medium size; and “11” indicates ejection of a droplet of a large size. The number-of-flushed-droplets retention register 4b retains the number of ink droplets (FL ejection count: FLEC) as information of the amount of ink to be ejected at the starting time of each pass in each nozzle 23. In the embodiment, at the flushing ejection time, a droplet of a predetermined size (for example, medium size) is ejected.

Referring again to FIG. 3, the interface 5 mediates data between the CPU 2 and the carriage drive circuit 11 and the paper feed drive circuit 12. The carriage drive circuit 11 drives the carriage motor 13 to move the carriage 21 in the primary scanning direction (horizontal direction) in accordance with a command of the CPU 2. The paper feed drive circuit 12 drives the paper feed motor 14 to operate the paper feed mechanism for conveying an image formation medium (for example, paper) in the secondary scanning direction (perpendicular direction) orthogonal to the primary scanning direction in accordance with a command of the CPU 2.

The DMAC 6 acquires data in the raster buffer 4a and the number-of-flushed-droplets retention register 4b of the RAM 4 and passes the data to the head interface 8 in accordance with a command of the CPU 2.

The head interface 8 passes the data passed from the DMAC 6 to the piezo drive circuit 9, which then expands and contracts the piezo-element 10 based on the passed data, thereby ejecting a droplet of a predetermined ink amount from the nozzle 23 of the head 22. In the embodiment, for example, droplets of three sizes of large, medium, and small different in ink amount can be ejected.

The CPU 2 controls the operation of the sections 3 to 6. It also transmits a command for operating the carriage 21 and the paper feed mechanism to the carriage drive circuit 11 and the paper feed drive circuit 12 through the interface 5. The CPU 2 also reads the programs stored in the program ROM 3 into the RAM 4 and executes the programs, thereby implementing freshness degree calculation means, comparison means, and ejection amount determination means to execute various types of processing.

Specifically, the CPU 2 calculates the freshness degree indicating the ink amount of fresh ink assumed to be previously supplied to the nozzle at the time of ejecting one droplet based on the amount of ink ejected between the flushing ejection time and the time of ejecting the one droplet to form an image portion in a raster and ink denaturation during the time interval.

In the embodiment, as the ink denaturation, the change percentage of the amount of the ink supplied to the nozzle (freshness degree coefficient) is used to calculate the freshness degree.

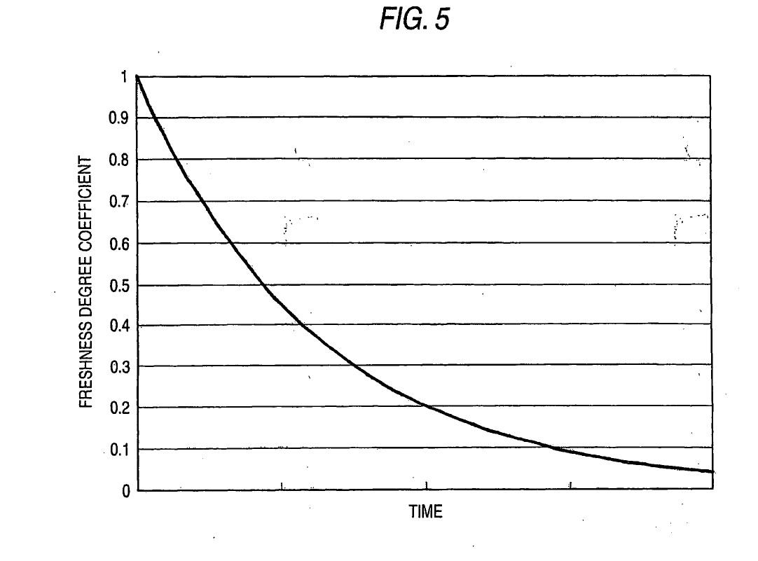

FIG. 5 is a drawing to describe the relationship between the freshness degree coefficient and the time according to the embodiment of the invention. The time “0” indicates the point in time at which ink has been ejected from the nozzle 23, in other words, the point in time at which new ink has been supplied to the nozzle 23.

The ink solvent evaporates and the ink amount decreases with the passage of time since ejection of ink from the nozzle 23 (since supply of ink to the nozzle 23) and thus the freshness degree coefficient of the ink lessens as shown in FIG. 5.

Referring again to FIG. 3, the CPU 2 makes a comparison between the calculated freshness degree and the freshness degree threshold value. If the comparison result between the freshness degree and the freshness degree threshold value is predetermined (for example, if it is determined that the freshness degree is less than the freshness degree threshold value or if it is determined that the freshness degree is equal to or less than the freshness degree threshold value), the CPU 2 determines the amount of ink to be ejected at the time of flushing ejection so that the freshness degree at the time of ejecting the one droplet becomes the freshness degree threshold value or more based on the difference between the freshness degree threshold value and the freshness degree and the ink denaturation between the flushing ejection time and the time of ejecting the one droplet.

Next, ink amount determination processing in the printer 1 according to the embodiment of the invention will be discussed with reference to the accompanying drawing.

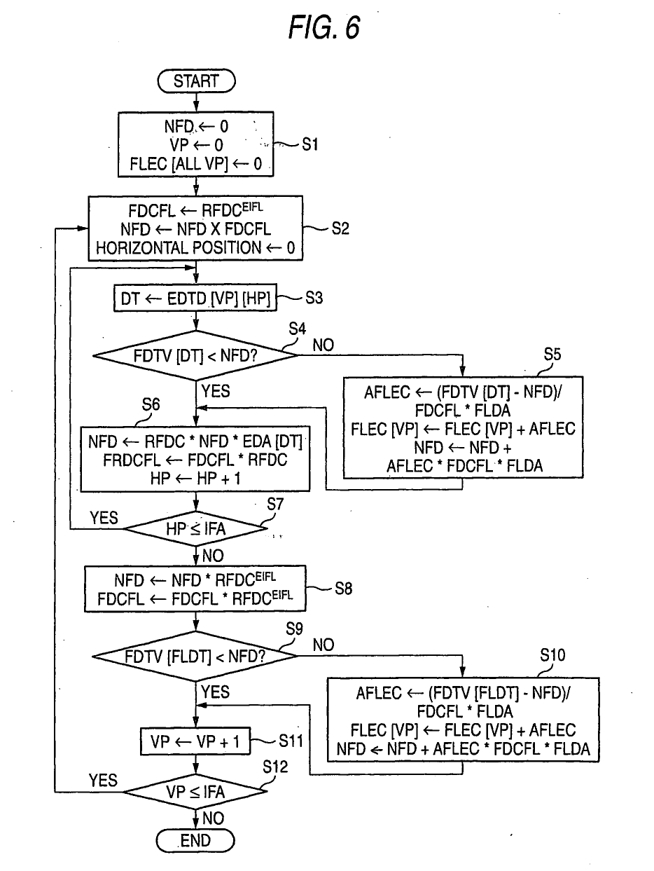

FIG. 6 is a flowchart of the ink amount determination processing according to the embodiment of the invention. It is a flowchart of processing of determining the ink amount for one nozzle. In the printer 1, similar processing is executed for all nozzles.

The CPU 2 performs the ink amount determination processing by executing the program stored in the program ROM 3.

To begin with, the CPU 2 stores “0” in a nozzle freshness degree (NFD) parameter in the RAM 4, stores “0” in a vertical position (VP) parameter, and stores “0” in the area corresponding to each path of the number-of-flushed-droplets retention register 4b (step S1). The area for storing the FL ejection count corresponding to the pass (vertical position) of the processing target of the number-of-flushed-droplets retention register 4b is shown as FL ejection count [vertical position].

Next, the CPU 2 acquires the reference freshness degree coefficient from the RAM 4, raises the reference freshness degree coefficient to the ejection interval FL'th power, stores the result in a freshness degree coefficient FL (FDCFL) parameter, multiplies the value of the nozzle freshness degree parameter by the value of the freshness degree coefficient FL parameter, stores the result in the nozzle freshness degree parameter, and stores “0” in a horizontal position (HP) parameter (step S2). The freshness degree coefficient FL parameter is a parameter indicating the freshness degree coefficient at the corresponding time (position) about the ink supplied by flushing ejection; at this point in time, it is the freshness degree coefficient at the point in time at which the nozzle is at the starting dot position of the image formation area. According to the processing step, the freshness degree coefficient at the point in time at which the nozzle is at the starting dot position of the image formation area can be easily and rapidly calculated using the reference freshness degree coefficient and the ejection interval FL.

Next, the CPU 2 stores the ejected droplet type data at the vertical position and the horizontal position of the processing target in a droplet type (DT) parameter from the raster buffer 4a (step S3). The ejected droplet type data at the vertical position and the horizontal position of the processing target in the raster buffer 4a is shown as ejected droplet type data [vertical position] [horizontal position].

Next, the CPU 2 acquires the freshness degree threshold value (FDTV) corresponding to the droplet type stored in the droplet type parameter from the RAM 4 and makes a comparison between the value of the nozzle freshness degree parameter and the freshness degree threshold value to determine whether or not the value of the nozzle freshness degree parameter is larger than the freshness degree threshold value (step S4).

As the result of the comparison, if it is determined that the value of the nozzle freshness degree parameter is larger than the freshness degree threshold value, it means that sufficient freshness for ejecting ink is included at the position, and thus the process goes to step S6. On the other hand, if it is determined that the value of the nozzle freshness degree parameter is equal to or less than the freshness degree threshold value, the CPU 2 subtracts the freshness degree threshold value of the droplet type corresponding to the value of the nozzle freshness degree parameter from the value of the freshness degree threshold value nozzle freshness degree parameter of the corresponding droplet type and divides the result by the result of multiplying the value of the freshness degree coefficient FL parameter by the ink amount of one droplet at the flushing ejection time (FL droplet amount stored in the RAM 4). The difference between the freshness degree threshold value of the droplet type corresponding to the value of the nozzle freshness degree parameter and the value of the nozzle freshness degree parameter indicates the freshness insufficient at the position. The result of multiplying the value of the freshness degree coefficient FL parameter by the FL droplet amount (FLDA) indicates the freshness that can be increased at the position when flushing ejection of one droplet is performed. Thus, the result produced by dividing the former by the latter becomes the necessary minimum number of ink droplets to be additionally ejected at the flushing ejection time.

Next, the CPU 2 stores the number of droplets in an additional FL ejection count (AFLEC) parameter. The CPU 2 adds the value of the additional FL ejection count parameter to the value of the FL ejection count [vertical position] in the number-of-flushed-droplets retention register 4b and stores the result in the FL ejection count [vertical position]. Accordingly, the total number of ink droplets to be ejected at the flushing ejection time is stored in the FL ejection count [vertical position]. The CPU 2 multiplies the value of the additional FL ejection count parameter by the value of the freshness degree coefficient FL parameter by the FL droplet amount, adds the result to the value of the nozzle freshness degree parameter, and stores the addition result in the nozzle freshness degree parameter (step S5). Accordingly, the freshness degree reflecting the droplets added in the flushing ejection is stored in the nozzle freshness degree parameter.

Next, the CPU 2 multiplies the reference freshness degree coefficient by the value of the nozzle freshness degree parameter, adds ejected droplet amount [droplet type] indicating the amount of ink to be ejected at the position to the multiplication result, and stores the addition result in the nozzle freshness degree parameter. Accordingly, the freshness degree at the next position is stored in the nozzle freshness degree parameter. The CPU 2 adds the value of the freshness degree coefficient FL parameter and the reference freshness degree coefficient and stores the result in the freshness degree coefficient FL parameter. Accordingly, the freshness degree coefficient (freshness degree coefficient FL) from the flushing ejection time at the next processing target position is stored in the freshness degree coefficient FL parameter. Next, the CPU 2 adds one to the value of the horizontal position parameter and stores the result in the horizontal position parameter, thereby setting the next horizontal position to the processing target (step S6).

Next, the CPU 2 determines whether or not the horizontal position of the processing target is within the image formation area (step S7). If the horizontal position is within the image formation area, the CPU 2 again executes the steps starting at step S3; if the horizontal position is not within the image formation area, the CPU 2 goes to step S8.

At step S8, the CPU 2 raises the reference freshness degree coefficient to the ejection interval FL'th power, multiplies the result by the value of the nozzle freshness degree parameter, and stores the result in the nozzle freshness degree parameter. Accordingly, the nozzle freshness degree at the next flushing ejection position is stored in the nozzle freshness degree parameter. The CPU 2 raises the reference freshness degree coefficient to the ejection interval FL'th power, multiplies the result by the value of the freshness degree coefficient FL parameter, and stores the result in the freshness degree coefficient FL parameter. Accordingly, the freshness degree coefficient (freshness degree coefficient FL) from the immediately preceding flushing ejection time at the next flushing ejection position is stored in the freshness degree coefficient FL parameter.

Next, the CPU 2 acquires the freshness degree threshold value corresponding to the FL droplet type (predetermined droplet type in flushing) from the RAM 4 and makes a comparison between the value of the nozzle freshness degree parameter and the freshness degree threshold value to determine whether or not the value of the nozzle freshness degree parameter is larger than the freshness degree threshold value (step S9).

As the result of the comparison, if it is determined that the value of the nozzle freshness degree parameter is larger than the freshness degree threshold value, it means that sufficient freshness for ejecting ink is included at the next flushing ejection position, and thus the process goes to step S11. On the other hand, if it is determined that the nozzle freshness degree is equal to or less than the freshness degree threshold value, the CPU 2 subtracts the value of the freshness degree threshold value nozzle freshness degree parameter of the FL droplet type (FLDT) from the value of the freshness degree threshold value nozzle freshness degree parameter of the FL droplet type and divides the result by the result of multiplying the value of the freshness degree coefficient FL parameter by the droplet amount at the flushing ejection time (FL droplet amount). The difference between the freshness degree threshold value of the FL droplet type and the value of the nozzle freshness degree parameter and the value of the nozzle freshness degree parameter and the freshness degree threshold value of the FL droplet type indicates the freshness insufficient at the next flushing ejection position. The result of multiplying the value of the freshness degree coefficient FL parameter by the FL droplet amount indicates the freshness that can be increased at the next flushing ejection position when flushing ejection of one droplet is performed at the immediately preceding flushing ejection position. Thus, the result produced by dividing the former by the latter becomes the necessary minimum number of ink droplets to be additionally ejected at the immediately preceding flushing ejection time.

Next, the CPU 2 stores the calculation result in the additional FL ejection count parameter. The CPU 2 adds the value of the additional FL ejection count parameter to the value of the FL ejection count [vertical position] in the number-of-flushed-droplets retention register 4b and stores the result in the FL ejection count [vertical position]. The CPU 2 multiplies the value of the additional FL ejection count parameter by the value of the freshness degree coefficient FL parameter by the FL droplet amount, adds the result to the value of the nozzle freshness degree parameter, and stores the addition result in the nozzle freshness degree parameter (step S10). Accordingly, the freshness degree reflecting the droplets added in the flushing ejection is stored in the nozzle freshness degree parameter.

Next, the CPU 2 adds one to the value of the vertical position parameter and stores the result in the vertical position parameter, thereby setting the next vertical position (pass) to the processing target (step S11).

Next, the CPU 2 determines whether or not the vertical position of the processing target is within the image formation area (step S12). If the vertical position is within the image formation area, the CPU 2 again executes the steps starting at step S2 about the vertical position; if the vertical position is not within the image formation area, it means that the ink amount for flushing ejection has been calculated about every pass in the vertical direction and therefore the processing is terminated.

Accordingly, the number of ink droplets to be ejected as flushing is stored in the number-of-flushed-droplets retention register 4b before image formation in every pass.

According to the processing, the flushing ejection amount can be decreased effectively in the range in which it can be ensured that ink droplets to be ejected to form an image and ink droplets at the flushing ejection time can be ejected appropriately.

In the printer 1 of the embodiment, to form an image, the DMAC 6 reads the data of the number of ink droplets to be ejected as flushing in the number-of-flushed-droplets retention register 4b from the RAM 4, and passes the data through the head interface 8 to the piezo drive circuit 9. The piezo drive circuit 9 performs flushing ejection at the image forming time in each pass based on the passed data of the number of ink droplets to be ejected as flushing. Since the number of ink droplets in the flushing ejection is the number of droplets determined according to the ink amount determination processing described above, wasteful ink can be decreased effectively and droplets to form an image can be ejected appropriately. Accordingly, a high-quality image can be formed on an image formation medium.

While the invention has been described based on the embodiment, it is to be understood that the invention can be applied not only to the embodiment described above, but also to other various embodiments.

For example, in the embodiment described above, the invention is applied to the ink jet printer for ejecting ink droplets using the piezo-element, but the invention is not limited to it and can also be applied to an ink jet printer for ejecting ink droplets by heating ink, for example.

In the embodiment described above, ink droplets to form an image are ejected at the moving time in both directions of the primary scanning direction, but the invention is not limited to the mode. For example, ink droplets to form an image may be ejected only at the moving time in one direction.

In the description of the embodiment, the case where the move time of the nozzle from the flushing ejection position to the starting end of the image formation area and the move time of the nozzle from the last end of the image formation area to the flushing ejection position are the same is taken as an example, but the invention is not limited to it. The times may differ. In this case, the freshness degree coefficient and the ink freshness degree may be calculated in response to the times.

In the embodiment described above, the computer in the printer executes the ink amount determination processing, but the invention is not limited to it. For example, the ink amount determination processing may be executed as a computer connected to the printer executes the program.

What is claimed is:

1. An ink ejecting apparatus comprising:
a nozzle, configured to perform a first flushing ejection of ink at a flushing position at a first timing, and configured to perform a dot forming ejection of ink to form an image on a target medium while moving in a first direction at least once after the first flushing ejection is performed;
a first calculator, configured to calculate a first amount of fresh ink assumed to be supplied to the nozzle at a second timing that an ink droplet is ejected in the dot forming ejection, based on denaturation of ink occurred between the first timing and the second timing, and an amount of ink to be ejected between the first timing and the second timing;
a first storage, storing a second amount of fresh ink to be supplied to the nozzle to perform the dot forming ejection at the second timing;
a comparator, configured to compare the first amount with the second amount to calculate a difference therebetween;
a second calculator, configured to calculate a third amount of ink to be ejected by the first flushing ejection so that the first amount becomes no less than the second amount based on the difference and the denaturation of ink; and
a second controller, configured to cause the nozzle to eject the third amount of ink at the first timing.

2. The ink ejecting apparatus according to claim 1, wherein:
the second timing is every timing that an ink droplet is ejected in the dot forming ejection.

3. The ink ejecting apparatus according to claim 2, wherein:
the nozzle is configured to perform a second flushing ejection of ink at a third timing after the dot forming ejection is performed;
the first calculator is configured to calculate a fourth amount of fresh ink assumed to be supplied to the nozzle at the third timing;
the comparator is configured to compare the fourth amount with the second amount; and
the second calculator is configured to calculate the third amount so that the fourth amount becomes no less than the second amount.

4. The ink ejecting apparatus according to claim 1, wherein:
the nozzle is configured to eject different amounts of ink; and
the second amount includes different values each of which is associated with one of the different amounts.

5. The ink ejecting apparatus according to claim 1, wherein:
a second storage, storing a first coefficient indicating a rate of ink denaturation occurred during a first time period that the nozzle moves from a first position that a first ink droplet for the dot forming ejection is ejected to a second position that a second ink droplet for the dot forming ejection is ejected; and
the first calculator is configured to calculate the first amount at the second position by multiplying the first amount at the first position by the first coefficient and adding an amount of the first ink droplet.

6. The ink ejecting apparatus according to claim 1, wherein
the second calculator is configured to divide the difference by a second coefficient indicating a rate of ink denaturation occurred between the first timing and the second timing to calculate the third amount.

7. The ink ejecting apparatus according to claim 6, further comprising
a third storage, storing a multiple number (M) indicating a second time period that the nozzle moves from the flushing position to a third position that the nozzle becomes capable of ejecting an ink droplet for the dot forming ejection is what times the first time period, wherein
the second calculator is configured to:
calculate a third coefficient indicating a rate of ink denaturation occurred during the second time period by raising the first coefficient to the M-th power; and
calculate the second coefficient by multiplying the third denaturation rate by a fourth coefficient indicating a rate of ink denaturation occurred during a third time period that the nozzle moves from the third position to the first position.

8. A method for calculating an amount of ink to be ejected at a flushing ejection by an ink ejecting apparatus including a nozzle, configured to perform a first flushing ejection of ink at a flushing position at a first timing, and configured to perform a dot forming ejection of ink to form an image on a target medium while moving in a first direction at least once after the first flushing ejection is performed, the method comprising:
calculating a first amount of fresh ink assumed to be supplied to the nozzle at a second timing that an ink droplet is ejected in the dot forming ejection, based on denaturation of ink occurred between the first timing and the second timing, and an amount of ink to be ejected between the first timing and the second timing;
comparing the first amount with a second amount of fresh ink to be supplied to the nozzle to perform the dot forming ejection at the second timing to calculate a difference therebetween; and
calculating a third amount of ink to be ejected by the first flushing ejection so that the first amount becomes no less than the second amount based on the difference and the denaturation of ink.

9. A computer program product storing a computer program configured to causing a computer to execute the method as set forth in claim 8.
